(19) United States
(12) Patent Application Publication
(10) Pub. No.: US 2008/0182745 A1
(43) Pub. Date: Jul. 31, 2008

(54) SUPPORTED PLATINUM AND PALLADIUM CATALYSTS AND PREPARATION METHOD THEREOF

(75) Inventors: Gennadi FINKELSHTAIN, Shoham (IL); Shimshon KOGAN, Beer Sheva (IL); Nino BORCHTCHOUKOVA, Bat-Iam (IL); Vladimir Sobyanin, Novosibirsk (RU); Anatoly Romanenko, Novosibirsk (RU); Pavel Simonov, Novosibirsk (RU)

Correspondence Address: GREENBLUM & BERNSTEIN, P.L.C., 1950 ROLAND CLARKE PLACE, RESTON, VA, 20191, US

(73) Assignee: MORE ENERGY LTD., Lod (IL)

(21) Appl. No.: 11/668,761

(22) Filed: Jan. 30, 2007

(51) Int. Cl. H01M 4/92

(52) U.S. Cl. 502/101; 502/326

(57) ABSTRACT

A method of preparing a supported platinum and/or palladium electrocatalyst and the electrocatalyst produced thereby. The method comprises the contacting of an electrically conductive particulate support which comprises adsorbed polynuclear hydroxo complexes of platinum and/or palladium with a reducing agent. This Abstract is not intended to define the invention disclosed in the specification, nor intended to limit the scope of the invention in any way.

### BACKGROUND OF THE INVENTION

1. Field of the Invention

The present invention relates to a finely divided supported platinum and/or palladium electrocatalyst which is useful, for example, for catalyzing the oxidation of borohydride compounds at the anode of a liquid fuel cell, and to a method of preparing the catalyst.

2. Discussion of Background Information

Conventional electrocatalysts for, e.g., various kinds of fuel cells contain noble metals such as, for example, platinum, ruthenium, rhodium, palladium, gold and silver, supported on an electrically conductive carrier. The metal content in these catalysts often is up to 60 wt. %, in most cases 20-40 wt. %. The presence of considerable amounts of such expensive and scarce materials in an electrocatalyst significantly affects (increases) the price thereof and in turn that of fuel cells using such catalysts as anode material, which restricts their applications.

The need for considerable concentrations of noble metals in electrocatalysts is due to the demand for a high electrochemical activity of, for example, electrodes. A low activity can be due to several different factors, such as:
1. slow electrochemical kinetics (often observed in electrocatalysts for the reduction of oxygen or the oxidation of methanol);
2. low electrochemically active metal surface (common in polymer electrolytes, wherein the surfaces of metal particles are often not completely wetted);
3. low specific surface area of the supported metal (for example, in cases where a significant portion of the catalytically active metal on the outer surfaces and within the pores of the support particles is not available for a contact with the species to be reduced or oxidized);
4. high chemical inhomogeneity of (poly)metal particles, especially at a low metal content on the support surface (as a result of insufficient mobility of metal particles and/or hindered coalescence at the low-temperature reduction of compounds of the catalytic metal);
5. diffusion limitations imposed on electrochemical processes by a non-optimal distribution of active component particles within the pores and the outer surfaces of the support particles.

In view of the foregoing factors, if a high content of noble metals in electrocatalysts is necessary for compensating the negative effects of the factors set forth under 3.-5., it should be possible to significantly lower the concentration of noble metals without decreasing the activity of the catalyst if the drawbacks caused by one or more of these factors can be eliminated or at least significantly reduced or compensated. It would thus, be desirable to have available a method for the preparation of electrocatalysts which improves the chemical homogeneity and dispersity of the active metal components of the catalysts and ensures an optimal distribution of the catalytically active metals throughout the support particles.

Example 1 of co-pending U.S. patent application Ser. No. 11/434,795, filed May 17, 2006, the entire disclosure whereof is incorporated by reference herein, discloses the preparation of a catalyst which is suitable for catalyzing the oxidation of, e.g., a borohydride compound such as sodium borohydride at the anode of a direct liquid fuel cell. This catalyst comprises 5 wt. % of Pt and 5 wt. % of Pd on a carbon support, i.e., Vulcan XC-72. The catalyst is prepared by heating a suspension of the carbon support in an aqueous solution of H₂PtCl₆ and H₂PdCl₄ and by subsequently precipitating the metals with a reducing agent, i.e., HCOOH.

This production method is not completely satisfactory in that it results in a chemical inhomogeneity of the formed metal particles. This is evidenced by the data obtained by microprobing the resultant catalyst by means of Energy-Dispersive X-Ray Spectrometry. Specifically, the data indicate a bi-modal distribution of the metal particle sizes. Coarse metal particles of 10-30 nm contain predominantly palladium (atomic ratio Pd:Pt=9:1), whereas smaller particles are enriched with platinum (from Pd:Pt=6:4 for 10 nm particles to Pd:Pt=4:6 for 5 nm particles). Further, according to XRD data obtained from a catalyst sample, the average size of metal crystallites in the catalyst is about 11 nm. On the other hand, the optimal particle size of the active catalyst component in most electrochemical processes is in the range of from about 2 nm to about 4 nm. This means that the total amount of noble metals in this catalyst can theoretically be decreased by about 50 to 70% (i.e., down to about 3-5 wt. %) without a decrease in the catalyst activity by increasing the dispersity of the metal particles so that their total catalytically active surface is approximately the same as that of the catalyst with the high metal content. A further decrease in the content of noble metals in the catalyst (down to 2%) without loss of activity would be possible by concentrating the active component of the catalyst in the periphery (i.e., on the outer surfaces) of the support particles, which would result in a decrease of diffusion inhibition in electrochemical processes.

U.S. Pat. No. 3,804,779, the entire disclosure whereof is incorporated by reference herein, describes a method of producing palladium catalysts by hydrolysis of a Pd^{II} compound such as PdCl₂ and subsequent precipitation of the resultant colloidal metal hydroxide on a carbon support surface. The structure of these colloids as well as their formation and adsorption by carbon materials have been studied in detail (Izv. Akad. Nauk SSSR, Chemical Series, 1993, No. 4, pp. 675-680; ibid, 1995, No. 10, pp. 1901-1905; Kinetics & Catalysis, 2000, Vol. 41, No. 2, pp. 255-269; the entire disclosures of these documents are incorporated by reference herein). It was shown that the addition of an alkaline agent to Na₂PdCl₄ leads to the formation of colloidal particles of polynuclear hydroxo complexes (PHC) of palladium having the composition {Pd(OH)₂}ₙ mNaCl (m<n). Their average size is about 2.0 nm, which size probably is influenced by the composition of the corresponding solution, since the particles included occluded electrolytes. Palladium PHC are characterized by a high adsorbability on the surface of quasi-graphitic carbon materials and can be readily reduced even by weak reducing agents such as formate ions, thereby providing supported metallic palladium particles having an average size of about 1.5-2.0 nm. Colloidal solutions on the basis of these polynuclear hydroxo complexes are rather stable against coagulation because of the existence of an ionic coat of Cl⁻ anions around each of the PHC particles, which anions are connected to the surfaces of said particles by Coulomb's forces.

The above structural and chemical features of palladium PHC can be used for developing approaches toward the creation of polymetallic catalysts on the basis of palladium. Complex anions of other metals, for instance, [PtCl₆]²⁻ or [PtCl₄]²⁻, can substitute Cl⁻ ions on the surface of palladium PHC, thereby affording bimetallic species. Chloride complexes of platinum are kinetically rather inert with respect to the substitution of ligands in their coordination sphere. Therefore, the hydrolysis of such complexes proceeds relatively slowly and is often accelerated either catalytically or photochemically. Hydroxides and oxides of transition metals can play the role of such hydrolysis catalysts (see, e.g., S. I. Pechenyuk, Sorption-hydrolytic precipitation of platinum-type metals on the surface of inorganic sorbents. Leningrad: Nauka, 1991, pages 246 et seq., the entire disclosure whereof is incorporated by reference herein). This means that even if platinum is not incorporated into a palladium PHC structure through ion exchange in the form of complex chloride anions, it will likely precipitate on the surface thereof through catalyzed hydrolysis. Most likely, these processes co-exist, their ratio being determined by the pH value of the corresponding medium.

The present inventors have found that the joint hydrolysis of chloride complexes of Pd^{II} and Pt^{IV} and/or Pt^{II} results in the formation of bimetallic colloidal particles of hydroxo complexes of these metals, which ensures a good mixing of the metal atoms during a reduction of corresponding colloids. In this regard, it is to be noted that a high dispersity of palladium PHC results in a high dispersity of the Pd/Pt particles prepared therefrom. In particular, the ability of the PHC to be adsorbed in large amounts on active carbon surfaces combined with their relatively low mobility (in comparison with the initial mononuclear complexes of their predecessors) ensures a metal distribution predominantly over the periphery (i.e., the outer surfaces) of the support particles in the final electrocatalyst.

It also was found that the type of metal distribution over the support particles depends on the way of contacting the three components—support, alkaline agent and noble metals. Consequently, the feeding rate of the alkaline agent and the method (sequence) of contacting the alkaline agent with the carbon support and the noble metal species are factors which affect the synthesis of the catalysts and determine to a significant extent the metal distribution on and within the support particles.

### SUMMARY OF THE INVENTION

The present invention provides a method of preparing a supported platinum and/or palladium electrocatalyst. The method comprises contacting with a reducing agent an electrically conductive particulate support (for example, a carbon support) comprising adsorbed polynuclear hydroxo complexes (PHC) of platinum (Pt) and/or palladium (Pd).

In one aspect of this method, the PHC may comprise at least platinum, for example, both platinum and palladium. In the latter case, the atomic ratio Pt:Pd may, for example, be from about 10:1 to about 1:10, e.g., from about 5:1 to about 1:5, or from about 2:1 to about 1:2.

In another aspect of the method, the support may have a specific surface area of from about 50 m²/g to about 2,500 m²/g and/or at least about 700 m²/g, and/or the support may have a particle size of from about 0.5 μm to about 100 μm and/or the support may comprise from 0 to about 1.2 cm³/g of micropores.

In another aspect of the method, the support may comprise Pt and/or Pd, calculated as metals, in a total concentration of from about 0.5% to about 10% by weight based on the total weight of support plus metal(s). For example, the concentration may be not higher than about 5% by weight.

In another aspect, the reducing agent may comprise hydrogen gas. By way of non-limiting example, the support may be contacted with the hydrogen gas in the temperature range of from about 50° C. to about 300° C.

In yet another aspect, the reducing agent may comprise one or more agents selected from formic acid and salts thereof, borohydride compounds, hydrazine and formaldehyde. By way of non-limiting example, in this case the support may be contacted with the reducing agent in the temperature range of from about 10° C. to about 100° C., preferably in the temperature range of from about 60° C. to about 80° C.

In a still further aspect, the PHC may have been obtained by a process which comprises contacting in an aqueous medium Pd species and/or Pt species with an alkaline agent. For example, the Pd species and/or Pt species may comprise at least one halide complex of Pd or Pt. The halide complex may comprise a chloride complex such as, e.g., a chloride complex of at least one of Pt^{II}, Pt^{IV} and Pd^{II}. The alkaline agent may, for example, be selected from carbonates, bicarbonates and hydroxides of alkali and alkaline earth metals (such as, e.g., NaHCO₃, Na₂CO₃ and NaOH). The contacting of the Pt and/or Pd species may, for example, be carried out at a temperature in the range of from about 15° C. to about 30° C.

In one aspect, the contacting of the Pt and/or Pd species with the alkaline agent may be carried out prior to the contacting of the resultant mixture with the support and/or the Pt and/or Pd species may first be contacted with the support and thereafter contacted with the alkaline agent. In the first case the support may be contacted with an oxidant and/or an electrolyte, for example, prior to and/or concurrently with the contacting of the resultant mixture with the support. In the second case the support may be contacted with an oxidant and/or an electrolyte, for example, prior to and/or concurrently with the contacting of the support with the Pd and/or Pt species.

By way of non-limiting example, the oxidant may comprise one or more of H₂O₂, NaOCl, O₂, Cl₂ and HNO₃. The molar ratio oxidant:(Pt+Pd) metal may, for example, be from about 0.1:1 to about 1,000:1.

Also by way of non-limiting example, the electrolyte may comprise one or more of HCl, HClO₄, CH₃COOH, H₂SO₄, NaNO₃, Na₂SO₄, NaCl, CH₃COONa and NaClO₄.

The present invention also provides a method of preparing a carbon-supported platinum/palladium electrocatalyst. The method comprises the contacting with one or more reducing agents of a carbon support having a specific surface area of from about 50 m²/g to about 2,500 m²/g and comprising adsorbed polynuclear hydroxo complexes (PHC) of platinum (Pt) and palladium (Pd) at an atomic ratio Pt:Pd of from about 10:1 to about 1:10 in a total amount of from about 0.5% to about 10% by weight, calculated as metals and based on the total weight of carbon support plus metals. The reducing agent comprises one or more of hydrogen, formic acid and salts thereof, borohydride compounds, hydrazine and formaldehyde.

In one aspect of the method, the carbon support may have a particle size of from about 0.5 μm to about 100 μm and may comprise from 0 to about 1.2 cm³/g of micropores.

In another aspect, the atomic ratio Pt:Pd may be from about 5:1 to about 1:5, e.g., from about 2:1 to about 1:2.

In another aspect, the PHC may have been obtained by a process which comprises contacting in an aqueous medium a chloride complex of at least one of Pt^{II}, Pt^{IV} and Pd^{II} with an alkaline agent which comprises one or more of NaHCO₃, Na₂CO₃ and NaOH. By way of non-limiting example, this contacting may be carried out at a temperature in the range of from about 15° C. to about 30° C. The process may, for example, comprise (a) a contacting of the chloride complex with the alkaline agent prior to the contacting of the resultant mixture with the carbon support and/or (b) a contacting of the chloride complex with the carbon support and then a contacting thereof with the alkaline agent. Further, the carbon support may, for example, be contacted with an oxidant selected from one or more of H₂O₂, NaOCl, O₂, Cl₂ and HNO₃ (a) prior to and/or concurrently with the contacting of the resultant mixture with the carbon support and/or (b) prior to and/or concurrently with the contacting of the carbon support with the chloride complex.

The present invention also provides a method of preparing a supported platinum and/or palladium electrocatalyst, which method comprises contacting with a reducing agent an electrically conductive support (e.g., a carbon support) having a specific surface area of from about 50 m²/g to about 2,500 m²/g and comprising adsorbed species which have been obtained by a process which comprises the contacting of one or more halide complexes of at least one of Pt^{II}, Pt^{IV} and Pd^{II} with an alkaline agent in an aqueous medium.

In one aspect of this method, the one or more halide complexes may comprise at least one chloride complex and/or the alkaline agent may comprise one or more agents which are selected from carbonates, bicarbonates and hydroxides of alkali and alkaline earth metals.

In another aspect of the method, the atomic ratio Pt:Pd may be from about 10:1 to about 1:10, e.g., from about 5:1 to about 1:5, or from about 2:1 to about 1:2.

In yet another aspect, Pt and/or Pd may be employed in an amount which results in a total amount of Pt and Pd of from about 0.5% to about 10% by weight, e.g., from about 2% to about 5% by weight, calculated as metals and based on the total weight of support plus metal(s).

In a still further aspect of the method, the reducing agent may be selected from one or more of hydrogen, formic acid and salts thereof, borohydride compounds, hydrazine and formaldehyde.

In yet another aspect, the method may comprise contacting the one or more halide complexes with the alkaline agent prior to the contacting of the resultant mixture with the support and/or may comprise a contacting of the one or more halide complexes with the support and then a contacting thereof with the alkaline agent.

The present invention also provides an electrocatalyst which is obtainable by the methods set forth above, including the various aspects thereof.

In one aspect of this electrocatalyst, the average crystal size of Pt and/or Pd on at least the outer surfaces of the particles of the support may be not higher than about 4 nm, e.g., not higher than about 3 nm (but usually higher than about 1 nm, e.g., higher than about 1.5 nm).

In another aspect, the Pt and/or Pd may be predominantly present on the outer surfaces of the particles of the support (as opposed to (inner) pore surfaces of the particles) or the Pt and/or Pd may be substantially evenly distributed between the pores and the outer surfaces of the particles of the support.

In yet another aspect, the electrocatalyst may have an activity, determined in a polarization test and expressed as Coulomb/weight unit of (Pt and/or Pd) metal, which is at least about 1.5 times, e.g., at least about 2 times or at least about 2.5 times the activity of an electrocatalyst which has been obtained by an identical process but without producing intermediate PHC and/or without contacting the Pd species and/or Pt species with an alkaline agent before contacting the support with the reducing agent.

The present invention also provides an electrocatalyst which comprises metallic Pt and/or metallic Pd supported on carbon particles. The crystals of the metallic Pt and/or metallic Pd are present predominantly on outer surfaces of the carbon particles and have an average size, at least on said outer surfaces, of not more than about 4 nm, e.g., not more than about 3 nm.

The present invention also provides (i) an anode for a liquid fuel cell which comprises an electrocatalyst of the present invention and (ii) a liquid fuel cell which comprises this anode. The fuel cell may, for example, be a direct liquid fuel cell and/or a portable fuel cell and/or may comprise a liquid fuel. The liquid fuel may, for example, comprise a hydride compound and/or a borohydride compound such as, e.g. NaBH₄ and/or KBH₄.

The present invention also provides a method of electrocatalytically oxidizing a borohydride compound in an alkaline medium. The method comprises contacting the borohydride compound with an electrocatalyst according to the present invention.

The present invention also provides a method of increasing the activity of a supported metallic Pt and/or Pd catalyst without increasing the amount of Pt and/or Pt used for the production of the catalyst. The method comprises contacting a support which comprises adsorbed polynuclear hydroxo complexes of Pt and/or Pd with a reducing agent. In one aspect of this method, the PHC may have been obtained by a process which comprises the contacting of one or more halide complexes of at least one of Pt^{II}, Pt^{IV} and Pd^{II} with an alkaline agent.

The present invention also provides a method of controlling at least one of the distribution, the dispersity and the particle size of a Pt and/or Pd catalyst on a particulate support. The method comprises the generation of polynuclear hydroxo complexes of Pt and/or Pd prior to contacting the support which comprises adsorbed Pt and/or Pd species with a reducing agent.

In one aspect of the method, at least the distribution of the metal particles between the pores of porous support particles and the outer surfaces of the support particles may be controlled. For example, the distribution may be controlled to afford support particles wherein the metal particles are predominantly or almost exclusively located on the outer surfaces of the metal particles.

In another aspect of the method, at least the size of the metal particles may be controlled. For example, the size may be controlled to afford an average metal particle size of not higher than about 4 nm, e.g., not higher than about 3 nm (and preferably not lower than about 1.5 nm).

### BRIEF DESCRIPTION OF THE DRAWINGS

The present invention is further described in the detailed description which follows, in reference to the accompanying drawings by way of non-limiting examples of exemplary embodiments of the present invention. In the drawings:

FIG. 1 shows a microphotograph at 20,000-fold magnification of the supported Pd—Pt catalyst obtained in Example 6 below generated by a HR TEM (High Resolution Transmission Electron Microscope);

FIG. 2 shows a microphotograph at 200,000-fold magnification of the supported Pd—Pt catalyst obtained in Example 6 generated by a HR TEM;

FIG. 3 shows a microphotograph at 200,000-fold magnification of the supported Pd—Pt catalyst obtained in Example 13 below generated by a HR TEM.

FIG. 4 shows a graph of integrated current density vs. applied potential in a polarization test employing the electrocatalysts obtained in the Examples below.

FIG. 5 shows a graph of power and energy afforded by an alkaline borohydride fuel cell with an anode comprising the electrocatalyst of Example 1 below as a function of time.

FIG. 6 shows a graph of power and energy afforded by an alkaline borohydride fuel cell with an anode comprising the electrocatalyst of Example 6 below as a function of time.

FIG. 7 shows a graph of power and energy afforded by an alkaline borohydride fuel cell with an anode comprising the electrocatalyst of Example 13 below as a function of time.

FIG. 8 shows a graph of power and energy afforded by an alkaline borohydride fuel cell with an anode comprising the electrocatalyst of Example 14 below as a function of time.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the present invention, a porous carbon support is a preferred type of electrically conductive support, although other types of electrically conductive supports may be used as well as long as they are capable of supporting Pt and/or Pd metal particles and the precursors thereof, respectively. Non-limiting examples of carbon materials which are suitable for use as the support employed according to the present invention include activated carbon (charcoal), carbon black, filamentary charcoals, nanotubes and pyrolytic carbon.

Carbon supports which are suitable for the purposes of the present invention are available from many commercial sources. Non-limiting examples of suitable commercially available sources are the products sold under the tradenames Vulcan XC-72, Vulcan P90, Black Pearls 2000, Black Pearls 450, Black Pearls 570, Regal 400, Regal 330 (all available from Cabot, USA), Picatif SC 10 (available from Pica USA Inc, Columbus, Ohio), Norit GSX, Norit DLC (both available from Norit, Netherlands), carbon AKC, HSAG-300CAT (available from Lonza, Switzerland) and Sibunit (available from the Institute of Technical Carbon, Omsk, Russia; see also U.S. Pat. No. 4,978,649, the entire disclosure whereof is incorporated by reference herein).

The specific surface area of the support material (determined according to the BET method with nitrogen gas) will usually be at least about 50 m²/g, e.g., at least about 60 m²/g, at least about 100 m²/g, at least about 500 m²/g, or at least about 700 m²/g, but will usually not be higher than about 2,500 m²/g, e.g., not higher than about 2,200 m²/g or not higher than about 2,000 m²/g.

The support material may or may not comprise micropores (i.e., pores having a diameter of less than about 2 nm). If micropores are present, the micropore volume will usually not exceed about 1.2 cm³/g, e.g., not exceed about 1.0 cm³/g, or not exceed about 0.8 cm³/g.

The support material will usually have a particle size which is not smaller than about 0.5 μm, e.g., not smaller than about 1 μm, not smaller than about 5 μm, or not smaller than about 10 μm, and not higher than about 100 μm, e.g., not higher than about 80 μm, or not higher than about 70 μm.

Especially in the case of carbon as support material, the support may be preliminarily oxidized by small doses of oxidants such as, e.g., oxygen (air), chlorine, HNO₃, H₂O₂, NaOCl, etc. in order to decrease the ability of the support to reduce complexes of the noble metals and to increase its wettability by water.

Suitable palladium and/or platinum compounds for use in the present invention include Pt and Pd compounds which are capable of forming polynuclear hydroxo complexes (PHC) when contacted with an alkaline agent in the presence of water. Non-limiting and preferred examples of corresponding compounds include halide (preferably chloride) complexes of Pt^{II}, Pt^{IV} and Pd^{II} such as, e.g., H₂PtCl₆, H₂PtCl₄, H₂PdCl₄, H₂PtBr₆, H₂PtBr₄ and salts thereof (e.g., alkali metal and ammonium salts) such as, e.g., Na₂PtCl₆, Na₂PtCl₄, K₂PtCl₆, Na₂PdCl₄ and (NH₄)₂PtCl₆. Compounds of noble metals different from Pt and Pd (such as, e.g., Ru, Rh, Au and Ag) may be employed in addition to those of Pt and/or Pd, although this is currently not preferred.

If both Pt and Pd compounds are employed, the atomic ratio Pt:Pd will usually be not higher than about 10:1, e.g., not higher than about 7:1, not higher than about 5:1, not higher than about 3:1, or not higher than about 2:1 and will usually be not lower than about 1:10, e.g., not lower than about 1:7, not lower than about 1:5, not lower than about 1:3, or not lower than about 1:2.

The weight percentage of noble metals, i.e., of Pt, Pd or (Pt plus Pd) on the support (e.g., carbon) in the final catalyst based on the total weight of support plus noble metal(s) will usually be not higher than about 10% by weight, e.g., not higher than about 8% by weight, not higher than about 6% by weight, not higher than about 5% by weight, or not higher than about 4% by weight, but will usually be not lower than about 0.5% by weight, e.g., not lower than about 1% by weight, not lower than about 1.5% by weight, not lower than about 2% by weight, or not lower than about 3% by weight.

Non-limiting examples of alkaline agents for use in the present invention include hydroxides, carbonates and bicarbonates of alkali and alkaline earth metals (e.g., Li, Na, K, Cs, Mg, Ca and Ba), Al, Zn and ammonium such as, e.g., sodium hydroxide, sodium carbonate, sodium bicarbonate and potassium carbonate, as well as ammonia and amines. Sodium carbonate and sodium bicarbonate are currently preferred alkaline agents. The alkaline agents can be employed individually or in any combinations thereof. For example, a first alkaline agent may be combined with the Pt and/or Pd compound(s) before the contacting of the same with the support and a second alkaline agent may be added to the mixture of support and added Pt and/or Pd compound(s).

The alkaline agent can be introduced at various stages of the synthesis of the catalysts of the present invention, i.e., before, during and/or after introducing the initial metal species. It is to be anticipated that the longer the contact of the initial species of the metal(s) (e.g., chloride complexes) with the (carbon) support is before a contact with the alkaline agent takes place or the more slowly the alkaline agent is introduced, the more uniform will be the distribution of the metal component of the electrocatalyst throughout and across the support (i.e., inside the pores and on the outer surfaces of the support particles). Conversely, if the Pt and/or Pd compounds are contacted with an alkaline agent before being allowed to contact the support it is to be anticipated that most of the metal of the final catalyst will be located on the outer surfaces of the support particles.

Non-limiting specific examples of reducing agents for use in the present invention include formic acid and salts thereof (e.g., the alkali and alkaline earth metal salts such as, e.g., sodium formate), hydride and borohydride compounds such as, e.g., NaBH₄, KBH₄, LiBH₄, Al(BH₄)₃, Zn(BH₄)₂, NH₄BH₄, (CH₃)₃NHBH₃, NaCNBH₃, LiAlH₄, NaAlH₄, CaH₂, LiH, NaH, and KH, hydrazine and derivatives thereof, formaldehyde, alkali and alkaline earth metal thiosulfates, sulfites, phosphates, hypophosphites and any combinations thereof. A currently preferred reducing agent is sodium formate. The reducing agent will usually be employed as a solution in an aqueous solvent, preferably water or water/alcohol. The amount of reducing agent will usually be at least slightly higher (e.g., at least about 10% higher) than the stoichiometric amount required for a complete reduction of the Pt and/or Pd species present.

Another non-limiting example of a reducing agent which is preferred for use in the present invention is hydrogen gas. In this case, it is preferred to isolate and dry the support with adsorbed alkali-treated Pt and/or Pd species thereon and to contact the dried support with hydrogen gas at elevated temperature, e.g., in the temperature range of from about 50° C. to about 300° C.

To produce an electrocatalyst of the present invention one may, for example, prepare a suspension of the support material (e.g., carbon particles) in a suitable liquid medium such as, e.g., water or a mixture of water with a water-miscible organic solvent (e.g., an alcohol such as methanol or ethanol) at a temperature in the range of, for example, from about 5° C. to about 95° C., preferably from about 15° C. to about 30° C. A solution of the alkaline agent(s) may be added to the suspension drop by drop under intense stirring. The solutions of the Pd and/or Pt compound(s) and the alkaline agent(s) can be added in any sequence or combination. For example, it may be advantageous to combine two or more noble metal solutions (or at least a part thereof) before their introduction into the suspension of the support material and/or to combine these solutions (or at least a part thereof) with the solution of the alkaline agent(s) (or at least a part thereof).

The choice of feeding sequence and combination of reagents is determined to a large extent by the desired metal distribution on the outside and on the inside (pores) of the support particles. For example, since bimetallic colloidal particles of Pt/Pd hydroxo complexes are strongly adsorbed on a carbon support surface, and are largely unable to penetrate deep into the pores of the support particles, in order to create shell catalysts, i.e., catalysts wherein a predominant portion (e.g., at least about 70%, at least about 80%, at least about 90%, or at least about 95%) of the metal(s) are present on external (outer) surfaces of the support particles, it is preferred to allow the starting platinum and/or palladium compounds to react with the alkaline agent(s) before the contact thereof with the support. This may be achieved, for example, by the preliminary contacting of the Pt/Pd compound(s) and the alkaline agent(s) before contacting them with the support suspension or by adding the solution of the alkaline agent(s) to the support suspension prior to the addition of the noble metal solution(s). In the first case, the process of colloid (PHC) formation is controllable by, e.g., the ageing time and/or composition of the mixture, and in the second case this process is controllable by, e.g., the feeding rates of the reagents and the time difference between the addition of the alkaline agent(s) and the addition of the noble metal compound(s).

Alternatively, if a relatively homogeneous distribution of the metals throughout the support particles (i.e., a relatively homogeneous distribution on both the internal (pore) and external surfaces of the support particles) is desired, a prolonged contact of the starting platinum and palladium compounds (complexes) with the support is preferably ensured before their interaction with the alkaline agent.

Complex chloride (and other) anions of palladium and platinum are rather strong oxidants (the potential of their reduction to metals is 0.6-0.7 V). Therefore, even at room temperature, a certain amount of these anions can be reduced by carbon. As a result, coarsely dispersed metal particles with a size of from 6-10 nm to several microns are predominantly formed on carbon support particles. This process is an undesired side reaction during the production of finely dispersed low-metal catalysts because the resultant products comprise coarsely dispersed crystallites of the metals. The extent of this reduction of noble metal compounds by the support can be significantly decreased by a preliminary oxidation of the support (carbon). This oxidation can be accomplished in various ways. For example, the (dry) support may be superficially oxidized before it is processed into a suspension. In the case of a support suspension, the oxidant may be added to the support suspension, for example, before contacting the suspension with the noble metal compounds and/or the oxidant may be combined with the noble metal compounds before contacting them with the support suspension. Non-limiting examples of suitable oxidants include H₂O₂, NaOCl, O₂, Cl₂ and HNO₃.

Another alternative for decreasing the extent of the premature reduction of the noble metal compounds by the (carbon) support is to decrease the oxidation potential of the Pd^{II}, Pt^{IV} and Pt^{II} anions by introducing a (considerable) excess of ligands, e.g., chloride ions. Further, the process of discharging these anions on the support surface can be affected by changing the nature and composition of the electrolyte, for example by adding foreign electrolytes such as, e.g., one or more of HCl, HClO₄, HOAc, H₂SO₄, NaNO₃, Na₂SO₄, NaCl, NaOAc and NaClO₄, to the suspension.

Upon completion of the precipitation of colloidal particles of polynuclear Pt/Pd hydroxo complexes on the support, the resultant mixture will usually be aged. Preferred aging conditions include a pH of the suspension of about 6 to about 8 and a temperature in the range of from about 15° C. to about 95° C. Aging times will usually be at least about 5 minutes, e.g., at least about 10 minutes, or at least about 20 minutes. The aging may last for several hours, but will usually be completed within not more than about 90 minutes, e.g., not more than about 60 minutes (in part also depending on the aging temperature). Without wishing to be bound by any theory, it is believed that during the aging period, the adsorbed particles of metal hydroxo complexes are partially converted into oxide compounds and thereby lose their ability to be transferred back into the solution in the course of the subsequent alkali addition at the reduction stage.

The reduction of the metal species adsorbed on the support (carbon) particles is preferably carried out by using at least one of HCOOH, NaCOOH, KCOOH, NaBH₄, KBH₄, N₂H₄ and CH₂O. A preferred pH range for the reduction is from about 5 to about 10. The reduction will usually be carried out at a temperature of at least about 10° C., e.g., at least about 30° C., at least about 50° C., or at least about 60° C., but usually not higher than about 100° C., e.g., not higher than about 90° C., or not higher than about 80° C. In the case of a reduction by using hydrogen gas, a preferred temperature range is from about 50° C. to about 300° C.

Upon completion of the reduction, the catalyst may be isolated by, e.g., filtration (in the case of a suspension), washed and then dried at elevated temperature, preferably in vacuo.

An anode for, e.g., a fuel cell can be made from the electrocatalyst of the present invention in a conventional manner well known to those of skill in the art. For example, a material comprising the electrocatalyst of the present invention may be converted into a paste. The paste may be applied onto a suitable two-dimensional substrate (e.g., a sheet of paper or metal), and the substrate with the electrocatalyst thereon may be brought into the desired shape and dimensions of the anode, optionally before or after reinforcement with, e.g., a metal grid or the like.

For forming the paste, the catalyst may be mixed with a liquid, e.g., water or a mixture thereof with a lower alcohol (such as, e.g., methanol, ethanol, propanol, isopropanol and butanol) and a suitable binder (such as, e.g., polytetrafluoroethylene).

The substrate may, for example, be carbon paper. The substrate with the catalyst paste thereon may be reinforced with a reinforcing element, e.g., a metal grid such as a nickel grid. A reinforcing element may be applied on one side or on both sides of the substrate. Also, two or more of the reinforced substrates may be combined, thereby forming sandwich or multilayer structures.

In addition to a wet process as set forth above, the anode can also be made by a dry process. By way of non-limiting example, the electrocatalyst of the present invention may be mixed, e.g., kneaded, with polymer particles, e.g., polytetrafluoroethylene particles. The resultant homogeneous mixture may then be converted into a sheet structure, e.g., by rolling. This sheet structure may then be brought into the desired shape and dimensions of the anode and further processed as set forth above with respect to the wet process.

The material comprising the electrocatalyst of the present invention may be employed as the anode of a liquid fuel cell. The cathode of the fuel cell may be any cathode that can be used with a liquid fuel cell. Examples thereof are well known to those of skill in the art. Preferably, the cathode is an air-breathing cathode. Non-limiting examples thereof include a cathode comprising Pt or Ni on an electrically conductive carrier such as carbon.

The structure of a typical fuel cell according to the present invention comprises an anode which in its operative state is in contact with a liquid fuel on one side, and is in contact with a liquid, solid or gel electrolyte on its other side, and a cathode which also is in contact with the liquid electrolyte on one side thereof. The other side of the cathode is in contact with an oxidant, preferably oxygen, air or any other oxygen containing gas or liquid, such as hydrogen peroxide.

A liquid fuel for use in a fuel cell of the present invention may be any fuel that is suitable for liquid fuel cells. By way of non-limiting example, the liquid fuel may comprise water and/or a (monohydric or polyhydric) lower alcohol (usually a saturated aliphatic alcohol), in combination with a substance such as, e.g., NaBH₄, KBH₄, LiBH₄, Al(BH₄)₃, Zn(BH₄)₂, NH₄BH₄, (CH₃)₂NHBH₃, NaCNBH₃, a polyborohydride, LiAlH₄, NaAlH₄, CaH₂, LiH, NaH, KH, Na₂S₂O₃, Na₂HPO₃, Na₂HPO₂, K₂S₂O₃, K₂HPO₃, K₂HPO₂, HCOOH, NaCOOH and KCOOH or any combination of two or more thereof. The lower alcohol may, for example, be an alcohol having 1 to 6, e.g., 1 to 4 carbon atoms, and 1 or more, e.g., 1 to 4, OH groups. Non-limiting examples thereof are methanol, ethanol, n-propanol, isopropanol, n-butanol, isobutanol, pentanol, hexanol, ethylene glycol, propylene glycol, glycerol, pentaerythritol and any combination of two or more thereof. The liquid fuel may also comprise a basic compound, e.g., for the purpose of stabilizing the fuel substance. The basic compound may be any suitable organic or inorganic base, for example, an inorganic hydroxide, non-limiting examples whereof are ammonium and (preferably alkali and alkaline earth) metal hydroxides, such as, e.g., NaOH, KOH and LiOH, and NH₄OH.

A liquid electrolyte that is suitable for use in a liquid fuel cell may comprise a base, for example an aqueous inorganic hydroxide. Non-limiting examples of the inorganic hydroxide are alkali metal hydroxides, such as, e.g., NaOH, KOH and LiOH. Non-limiting examples of liquid fuels and liquid electrolytes suitable for use in the fuel cell of the present invention are disclosed, for example, in U.S. Patent Application Publication Nos. 2002/0083640, 2002/0094459, 2002/0142196, 2003/0099876, 2005/0058882, 2006/0057437 and 2006/0147780 and in U.S. Pat. Nos. 5,599,640, 5,804,329, 6,544,877 and 6,773,470 the entire disclosures whereof are hereby incorporated by reference herein.

The surface area of the anode (and of the cathode) of a fuel cell of the present invention is not particularly limited. Usually, however, the surface area is at least about 0.5 cm², e.g., at least about 2 cm², at least about 5 cm², at least about 10 cm², at least about 20 cm², or at least about 30 cm². On the other hand, the surface area usually is not larger than about 500 cm², e.g., not larger than about 300 cm², not larger than about 200 cm², not larger than about 100 cm², not larger than about 75 cm², or not larger than about 50 cm².

The liquid fuel cell of the present invention can be used to supply electrical energy to a virtually unlimited number of electric and electronic devices. Non-limiting examples thereof are (cellular) phones, (portable) computers, PDAs, consumer electronics, (portable) medical devices and components and peripherals thereof. It may also be used as a generator for emergency situations such as a power outage, as disclosed in U.S. patent application Ser. No. 11/475,063, the entire disclosure whereof is incorporated by reference herein.

### EXAMPLES

In the Examples which follow the dispersity of the supported metals was determined by a pulse method from the carbon oxide chemisorption as the ratio CO/Me, i.e., the molar ratio of adsorbed CO to supported metals Me. The size of the metal particles in the catalyst was calculated on the basis of the chemisorption data as follows: d (nm)=1.08/(CO/Me). The state of the supported metals was studied by high-resolution electron microscopy (HR TEM) and X-ray diffraction (XRD), and their distribution over the support grain was studied by X-ray photoelectron spectroscopy (XPS), comparing the values of the atomic ratios Pt/C and Pd/C calculated from the intensities of the spectral lines of the metals and of carbon with the overall atomic ratio of metals and carbon calculated from an elemental analysis of the catalyst.

Example 1 describes a synthesis method for comparative purposes (see, Example 1 of U.S. patent application Ser. No. 11/434,795).

Examples 2-4 illustrate the effect of the way of adding H₂PtCl₆ and H₂PdCl₄ solutions to the support on catalyst dispersity.
Examples 4 and 5 illustrate the effect of hydrogen peroxide addition on catalyst dispersity.
Examples 4 and 6 illustrate the effect of up-scaling on catalyst dispersity.
Examples 3 and 7 as well as 8 and 9 illustrate the effect of the nature of the carbon support on catalyst dispersity.
Examples 5 and 8 illustrate the effect of reduction temperature on catalyst dispersity.
Examples 8 and 10 illustrate the effect of reducing agent on catalyst dispersity.
Examples 4 and 11-13 illustrate the effect of the way of mixing the noble metal solutions with alkaline agent on catalyst dispersity.
Examples 11-13 illustrate the effect of the duration of ageing of the nanoparticles of mixed Pt—Pd polynuclear hydroxo complexes on catalyst dispersity.
Examples 14-17 illustrate various ways of making catalysts with a total metal content of ≦4 wt % by varying the atomic ratio Pt:Pd.
Examples 18-21 and 22 illustrate various ways of making mono-metallic platinum (Examples 18-21) and palladium (Example 22) catalysts.
Examples 23 and 24 report test results obtained with the catalysts of Examples 1-22.

### Example 1 (Comparative)

600 ml of deionized water (pH=6-7, purified with ion-exchange device “Zelion”, Israel) is added to a mixture of 12.8 ml of a 0.2 molar (39 g of Pt/L) aqueous solution of H₂PtCl₆ (Aldrich) and 23.6 ml of a 0.2 molar (21.2 g of Pd/L) aqueous solution of PdCl₂ (Aldrich). Both (Pt and Pd) solutions contain 3 wt. % of conc. HCl. Both metal compounds are 99.9+% pure. The resultant solution is added to an aqueous slurry of 9.2 grams of carbon powder in 700 ml of deionized water. The carbon is Vulcan XC-72 type (Cabot Corp.), having a particle size of 10-30 μm, a specific surface area according to BET of 241 m²/g, a total pore volume of 0.42 cm³/g, a micropore volume of 0.04 cm³/g (measured by an apparatus Tristar 3000), and a moisture content of 5% by weight (determined by a moisture analyzer HR-73). The resultant suspension is stirred for about 30 min, whereafter 200 ml of 85% formic acid is added. The suspension is stirred for about one hour at about 100° C. and thereafter cooled to room temperature and filtered. The resultant filter cake is washed with deionized water to neutrality (pH 6-7) and thereafter dried in a vacuum furnace at about 90° C. for about 8 hours. The metal content in % by weight of the dried catalyst (determined, as in all of the present Examples, by SEM EDS, analyzer Quanta 200, Phillips) is Pt 5.0, Pd 5.0. The average crystal size is 11 nm (XRD data).

### Example 2

2 cm³ of a solution containing 0.025 g Pd (in the form of H₂PdCl₄, prepared by dissolving PdCl₂ (Aldrich) in conc. HCl at a molar ratio of PdCl₂:HCl=1:2; this solution is also used in the following Examples) and 0.1 cm³ of 30% H₂O₂ are added dropwise over 2 min to a suspension obtained by stirring 0.95 g of activated carbon (“Picatif SC 10” (Pica Co.), particle size 20-60 μm, specific surface area according to BET=2000 m²/g and micropore volume=0.710 cm³/g) in 10 cm³ of distilled water over 15 min at 20° C. The suspension is stirred for 5 min and thereafter 2 cm³ of a solution containing 0.025 g of Pt (in the form of H₂PtCl₆, prepared by dissolving the corresponding hydrate in deionized water; this solution is also used in the following Examples) is added over 2 min. Then the suspension is kept stirring for 15 min, and thereafter 5 cm³ of a solution containing 0.106 g of Na₂CO₃ is added over 5 min. After 20 min, the temperature is increased to 70° C. and the suspension is kept at this temperature for 20 min. Thereafter, 5 cm³ of a solution containing 0.106 g of Na₂CO₃ and 0.068 g of NaOOCH is added over 5 min, and then the suspension is aged for 20 min at 70° C. The catalyst is filtered and washed with distilled water up to a neutral reaction and absence of Cl⁻ ions in rinse waters (reaction with AgNO₃); then it is dried in vacuo at 100° C.

The resultant catalyst comprises 2.5 wt % of Pt and 2.5 wt % of Pd with an average crystal size of <2 nm (XRD). The average particle size is 1.50 nm (CO/Me=0.72).

### Example 3

The catalyst is prepared as in Example 2 with the exception that the metal addition sequence is reversed—first the H₂PtCl₆+H₂O₂ solution and thereafter the H₂PdCl₄ solution is added.

The resultant catalyst comprises 2.5 wt % of Pt and 2.5 wt % of Pd with an average crystal size of <2 nm (XRD). The average particle size is 1.48 nm (CO/Me=0.73).

### Example 4

The procedure described in Examples 2 and 3 is followed, but all of the solutions (H₂PtCl₆+H₂PdCl₄+H₂O₂) are combined into one and added over 10 min; also, the ageing time of the final suspension is increased to 40 min.

The resultant catalyst comprises 2.5 wt % of Pt and 2.5 wt % of Pd with an average crystal size of <2 nm (XRD). The average particle size is 1.42 nm (CO/Me=0.76).

### Example 5

The procedure of Example 4 is followed with the exception that no H₂O₂ is added and the ageing time of the final suspension is 20 min.

The resultant catalyst comprises 2.5 wt % of Pt and 2.5 wt % of Pd with an average crystal size of <2 nm (XRD). The average particle size is 1.77 nm (CO/Me=0.61).

### Example 6

The procedure is similar to that of Example 4, but on a larger scale and with the addition time of the noble metal solution reduced to 5 min.

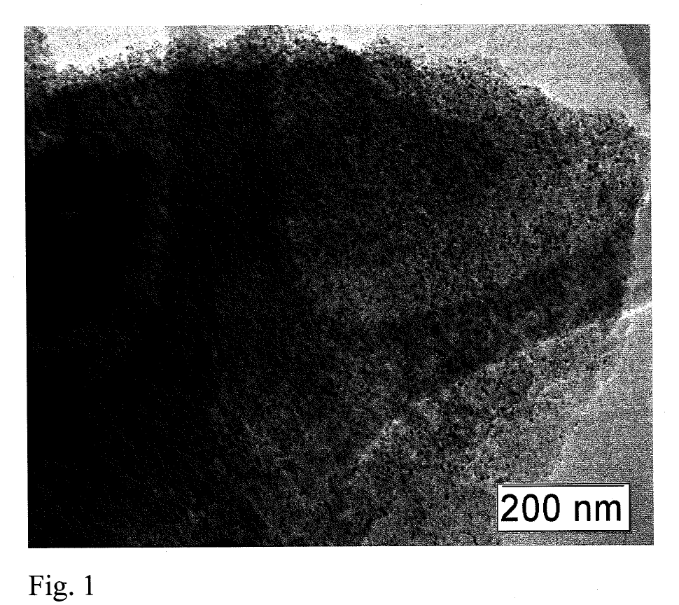

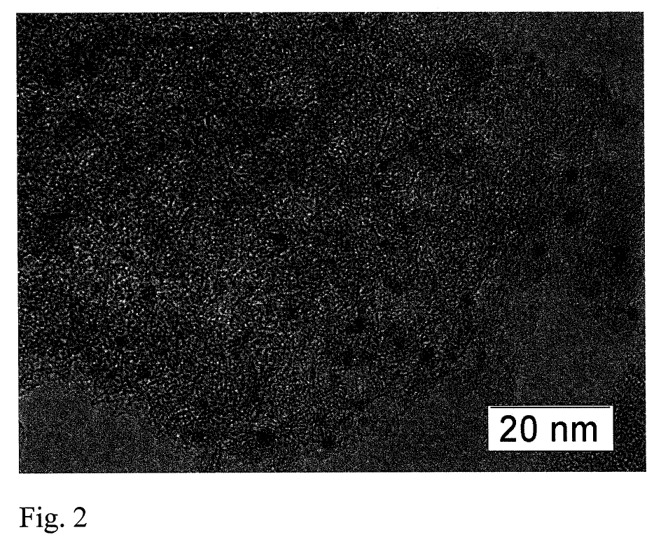

20 cm³ of a solution containing 0.684 g Pd (as H₂PdCl₄), 0.684 g Pt (as H₂PtCl₆) and 2.6 cm³ of 30% H₂O₂ are added dropwise over 5 min to a suspension obtained by stirring 26 g of activated carbon (used in Example 2, particle size 20-60 μm) in 300 cm³ of distilled water over 30 min at 20° C. The suspension is stirred for 15 min and thereafter 2 cm³ of a solution containing 0.025 g of Pt (as H₂PtCl₆) is added over 2 min. The resultant suspension is stirred for 15 min, and thereafter 30 cm³ of a solution containing 2.907 g of Na₂CO₃ is added over 10 min. After 20 min, the temperature is increased to 70° C. and the suspension is kept at this temperature for 20 min. 70 cm³ of a solution containing 2.907 g of Na₂CO₃ and 1.865 g of NaOOCH is added over 10 min, and thereafter the suspension is aged for 40 min at 70° C. The catalyst is filtered and washed with distilled water up to a neutral reaction and absence of Cl⁻ ions in rinse waters (reaction with AgNO₃); the catalyst is then dried in vacuo at 100° C.
The resultant catalyst comprises 2.5 wt % of Pt and 2.5 wt % of Pd with an average particle size of 1.71 nm (CO/Me=0.63). The ratios of signal intensities in the XPS spectra, i.e., Pt/C=0.0015, Pd/C=0.0033, are close to the overall atomic ratios Pt/C (=0.00162) and Pd/C (=0.00297) determined by elemental analysis. This indicates a substantially even distribution of noble metals throughout the support particles. Electron microscopy microphotographs of the catalyst are shown in FIGS. 1 and 2.

### Example 7

The catalyst is prepared as described in Example 3, with the only difference that acetylene black (Shawinigan Black® Acetylene Black. Lot # 1-243; SBET=64 m²/g) is used instead of the carbon support employed in Example 3.

The resultant catalyst comprises 2.5 wt % of Pt and 2.5 wt % of Pd with an average particle size of 3.27 nm (CO/Me=0.33).

### Example 8

10 cm³ of a solution containing 0.025 g Pd (as H₂PdCl₄) and 0.025 g Pt (as H₂PtCl₆) is added dropwise over 6 min to a suspension obtained by stirring 0.95 g of activated carbon (used in Example 2, particle size 20-60 μm) in 15 cm³ of distilled water over 30 min at 20° C. The suspension is stirred for 15 min and thereafter 5 cm³ of a solution containing 0.106 g of Na₂CO₃ is added over 5 min. The resultant suspension is stirred for 20 min, and thereafter 5 cm³ of a solution containing 0.106 g of Na₂CO₃ and 0.068 g of NaOOCH is added over 6 min. After 15 min, the temperature is increased to 60° C. and the suspension is kept at this temperature for 20 min. The catalyst is filtered and washed with distilled water up to a neutral reaction and absence of Cl⁻ ions in rinse waters (reaction with AgNO₃); the catalyst is then dried in vacuo at 100° C.

The resultant catalyst comprises 2.5 wt % of Pt and 2.5 wt % of Pd with an average particle size of 2.08 nm (CO/Me=0.52).

### Example 9

The catalyst is prepared as described in Example 8, with the only difference that acetylene black (SBET=64 m²/g) is used instead of the carbon support used in Example 8.

The resultant catalyst comprises 2.5 wt % of Pt and 2.5 wt % of Pd with an average particle size of 3.60 nm (CO/Me=0.30).

### Example 10

The catalyst is prepared as in Example 8, with the only difference that the Na₂CO₃ solution is added over 10 min and that before the addition of the Na₂CO₃+NaOOCH solution hydrogen is bubbled through the suspension for 20 min.

The resultant catalyst comprises 2.5 wt % of Pt and 2.5 wt % of Pd with an average crystal size of about 2 nm (XRD). The average particle size is 2.16 nm (CO/Me=0.50).

### Example 11

(1) A suspension of 0.95 g of activated carbon (used in Example 2, particle size 20-60 μm) in 15 cm³ of distilled water is prepared and stirred for 30 min at 20° C.

(2) A mixture of noble metal compound and Na₂CO₃ solutions is added dropwise to the suspension of (1) over 10 min. The mixing of the solutions (10 cm³ of a solution containing 0.025 g of Pd in the form of H₂PdCl₄ and 0.025 g of Pt in the form of H₂PtCl₆, and 10 cm³ of a solution containing 0.0905 g of Na₂CO₃) is performed in a continuous-flow ideal-mixing reactor, wherein the solutions are simultaneously fed at the same rate; mixing time=17 sec.
(3) The suspension of (2) is stirred for 30 min at 20° C., then the temperature is raised to 70° C. over 20 min, and 4 cm³ of a solution containing 0.0594 g of Na₂CO₃ and 0.1006 g of NaOOCH is added thereto over 5 min. The resultant suspension is stirred for 30 min at 70° C., and the catalyst is filtered and washed with distilled water up to a neutral reaction and absence of Cl⁻ ions (reaction with AgNO₃); the catalyst is then dried in vacuo at 100° C.
The resultant catalyst comprises 2.5 wt % of Pt and 2.5 wt % of Pd with an average particle size of 1.71 nm (CO/Me=0.63). The ratio of signal intensities in the XPS spectra is: Pt/C=0.0037, Pd/C=0.0060, whereas the overall ratios determined by elemental analysis are significantly lower, i.e., Pt/C=0.00162 and Pd/C=0.00297. This indicates a concentration of the noble metals on the outer surfaces of the carbon particles.

### Example 12

The catalyst is prepared as described in Example 11, with the only difference that the mixing time of the noble metal and Na₂CO₃ solutions in step (2) is increased to 20 min.

The resultant catalyst comprises 2.5 wt % of Pt and 2.5 wt % of Pd with an average crystal size of 3.5 nm (XRD). The average particle size is 3.86 nm (CO/Me=0.28).

### Example 13

An larger batch of catalyst (25 g Pd—Pt/C) is prepared as described in Example 11, with the mixing time of the noble metal and Na₂CO₃ solutions reduced to 10 sec.

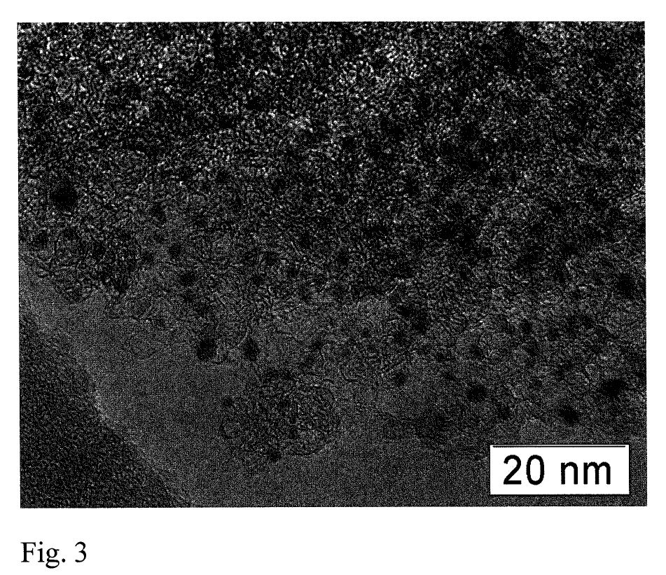

The resultant catalyst comprises 2.5 wt % of Pt and 2.5 wt % of Pd with an average particle size of 2.16 nm (CO/Me=0.50). The ratio of signal intensities in the XPS spectra is: Pt/C=0.0027, Pd/C=0.0045, whereas the overall ratios determined by elemental analysis are significantly lower, i.e., Pt/C=0.00162 and Pd/C=0.00297. This indicates a concentration of the noble metals on the outer surfaces of the carbon particles.
The electron microscopy photograph of the catalyst (FIG. 3) also points to a concentration of the noble metals on the outer surfaces of the carbon particles (compare FIGS. 2 and 3).

### Example 14

A batch of catalyst (25 g Pd—Pt/C) is prepared as described in Example 13, with the only difference that the content of each metal is reduced to 2% and that the Na₂CO₃ solution in step (2) additionally contains 2.5 cm³ of 30% H₂O₂.

The resultant catalyst comprises 2.0 wt % of Pt and 2.0 wt % of Pd with an average particle size of 2.63 nm (CO/Me=0.41).

### Example 15

5 cm³ of a solution containing 0.005 g of Pd (as H₂PdCl₄) is added dropwise over 10 min to a suspension obtained by stirring 0.97 g of activated carbon (used in Example 2, particle size 20-60 μm) in 10 cm³ of an aqueous solution containing 0.0504 g of Na₂CO₃ for 15 min at a temperature of 20° C. The resultant mixture is stirred for 30 min, whereafter the temperature is raised to 85° C. and the mixture is kept at this temperature for 15 min. Thereafter, 5 cm³ of a solution containing 0.025 g of Pt (as Na₂PtCl₆; obtained by mixing Na₂CO₃ and H₂PtCl₆ solutions) is added over 10 min. The resultant suspension is aged for 30 min at 85° C. The catalyst is filtered, washed with distilled water up to a neutral reaction and absence of Cl⁻ ions in rinse waters (reaction with AgNO₃) and dried in vacuo at 100° C. The dried catalyst is reduced by hydrogen in a continuous-flow reactor under atmospheric pressure and with the following temperature regime: 100° C. (0.5 hour) and then 120° C. (0.5 hour).

The resultant catalyst comprises 2.5 wt % of Pt and 0.5 wt % of Pd with an average particle size of 1.69 nm (CO/Me=0.64).

### Example 16

5 cm³ of a solution containing 0.025 g of Pd (as H₂PdCl₄) is added dropwise over 10 min to a suspension obtained by stirring 0.97 g of activated carbon (used in Example 2, particle size 20-60 μm) in 10 cm³ of an aqueous solution containing 0.252 g of Na₂CO₃ for 15 min at 20° C. The resultant mixture is stirred for 30 min, then the temperature is raised to 85° C. and the mixture is kept at this temperature for 15 min. Thereafter, 5 cm³ of a solution containing 0.005 g of Pt (as Na₂PtCl₆; obtained by mixing Na₂CO₃ and H₂PtCl₆ solutions) is added to the mixture over 10 min. The resultant suspension is aged for 30 min at 85° C. The catalyst is filtered, washed with distilled water up to a neutral reaction and absence of Cl⁻ ions in rinse waters (reaction with AgNO₃) and dried in vacuo at 100° C. The dried catalyst is reduced by hydrogen in a continuous-flow reactor under atmospheric pressure and with the following temperature regime: 100° C. (0.5 hour) and then 120° C. (0.5 hour).

The resultant catalyst comprises 0.5 wt % of Pt and 2.5 wt % of Pd with an average particle size of 2.70 nm (CO/Me=0.40).

### Example 17

5 cm³ of a solution containing 0.025 g of Pt (as H₂PtCl₆) is added dropwise over 10 min to a suspension obtained by stirring 0.97 g of activated carbon (used in Example 2, particle size 20-60 μm) in 10 cm³ of distilled water for 15 min at a temperature of 85° C. The resultant mixture is stirred for 15 min, and then 10 cm³ of an aqueous solution containing 0.0504 g of Na₂CO₃ is added thereto over 10 min. After 15 min, 5 cm³ of a solution containing 0.005 g of Pd (as H₂PdC₄) is added over 10 min. The resultant suspension is stirred for 30 min and then 1 cm³ of an aqueous solution containing 0.008 g of sodium formate is added thereto over 2 min. The resultant suspension is aged for 30 min at 85° C. The obtained catalyst is filtered, washed with distilled water up to a neutral reaction and absence of Cl⁻ ions in rinse waters (reaction with AgNO₃) and dried in vacuo at 100° C.

The resultant catalyst comprises 2.5 wt % of Pt and 0.5 wt % of Pd with an average particle size of 2.16 nm (CO/Me=0.50).

### Example 18

A suspension of 0.975 g of activated carbon (used in Example 2, particle size 20-60 μm) in distilled water is prepared, heated to 85° C. and stirred for 15 min. Thereafter, 5 cm³ of a solution containing 0.025 g of Pt (in the form of H₂PtCl₆) is added thereto over 10 min, whereafter the resultant mixture is stirred for 15 min. 2.5 cm³ of an aqueous solution containing 0.0544 g of Na₂CO₃ is added thereto over 5 min, whereafter stirring is continued for 30 min. The catalyst is filtered, washed with distilled water up to a neutral reaction and absence of Cl⁻ ions in rinse waters (reaction with AgNO₃) and dried in vacuo at 100° C. The dried catalyst is reduced by hydrogen in a continuous-flow reactor under atmospheric pressure and with the following temperature regime: 100° C. (0.5 hour) and then 120° C. (0.5 hour).

The resultant catalyst comprises 2.5 wt % of Pt with an average particle size of 1.30 nm (CO/Me=0.83).

### Example 19

The procedure described in Example 18 is followed, with the only difference that the suspension of the carbon support (used in Example 2, particle size 20-60 μm) is kept at 20° C., and H₂PtCl₆ is added at the same temperature.

The resultant catalyst comprises 2.5 wt % of Pt with an average particle size of 1.29 nm (CO/Me=0.84).

### Example 20

A suspension of 0.975 g of activated carbon (used in Example 2, grain size 20-60 μm) in 10 cm³ of an aqueous solution containing 0.0794 g of Na₂CO₃ is prepared, stirred for 15 min at 20° C. and then heated to 85° C. 5 cm³ of a solution containing 0.025 g of Pt (in the form of H₂PtCl₆) is added thereto over 10 min, whereafter stirring is continued for 30 min. The catalyst is filtered, washed with distilled water up to a neutral reaction and absence of Cl⁻ ions in rinse waters (reaction with AgNO₃) and dried in vacuo at 100° C. The dried catalyst is reduced by hydrogen in a continuous-flow reactor under atmospheric pressure and with the following temperature regime: 100° C. (0.5 hour) and then 120° C. (0.5 hour).

The resultant catalyst comprises 2.5 wt % of Pt with an average particle size of 1.44 nm (CO/Me=0.75).

### Example 21

The procedure described in Example 18 is followed, with the only difference that the reagent is scaled down for obtaining a 1% catalyst.

The resultant catalyst comprises 1.0 wt % of Pt with an average particle size of 1.48 nm (CO/Me=0.73).

### Example 22

A suspension of 25 g of activated carbon (used in Example 2, particle size 20-60 μm) in 200 cm³ of distilled water is prepared and stirred for 30 min at 20° C. 50 cm³ of a solution containing 1.316 g of Pd (in the form of H₂PdCl₄) and 1.5 cm³ of 30% H₂O₂ is added drop by drop to the suspension over 10 min. Then the suspension is stirred for another 15 min. Thereafter, 50 cm³ of a solution containing 2.623 g of Na₂CO₃ is added over 10 min, and the resultant mixture is stirred for 20 min at 20° C., whereafter the temperature is raised to 70° C. and the mixture is kept at this temperature for another 20 min. 70 cm³ of a solution containing 2.623 g of Na₂CO₃ and 1.70 g of NaOOCH is added thereto over 10 min, and then the suspension is stirred for another 40 min at 70° C. The catalyst is filtered, washed with distilled water up to a neutral reaction and absence of Cl⁻ ions (reaction with AgNO₃) and dried in vacuo at 100° C.

The resultant catalyst comprises 5.0 wt % of Pd with an average particle size of 1.83 nm (CO/Me=0.59).

### Example 23

The activity of the catalysts described in Examples 1-22 was compared in a polarization test with a potentiostat PAR Model 263. A standard 3-electrode electrochemical cell was used. The tested catalyst was the working electrode, Hg/HgO/KOH was the reference electrode, and Pt wire served as the counter electrode. The standard fuel was an aqueous solution containing 3.5 M KOH+1 M NaBH₄.

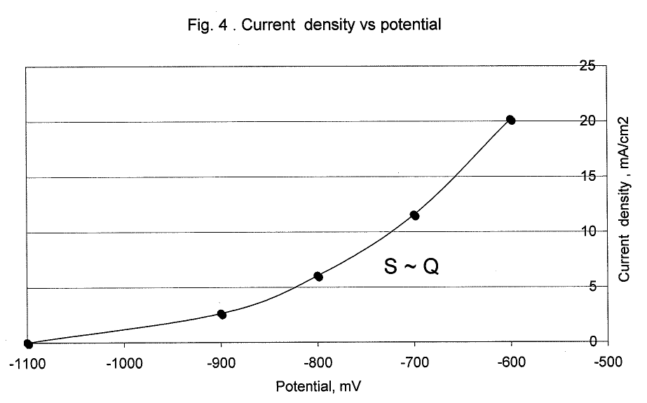

The potential range of measurement was −1.10÷−0.60 V.
The catalyst tested was prepared as follows:
A suspension containing 18 mg of the catalyst to be tested in 1 cc of a binder solution was prepared in an ultrasonic blender. 10 μl of the suspension (containing 0.18 mg of the catalyst) was used for the activity measurement.
The activity of the catalysts—Q in [C] (Coulomb) was evaluated as the integrated amount of electricity produced in the test at the potential change in the above-mentioned ranges (FIG. 4).
The results obtained were calculated for both 1 mg of catalyst and 1 mg of noble metals (Tables 1 and 2).

### Example 24

In this example, the effectiveness of the catalysts obtained in Examples 1, 6, 13 and 14 as active component of the anode of a fuel cell was tested. The anode was manufactured in accordance with dry technology. The catalyst was mixed with polytetrafluorethylene (PTFE). The amount of catalyst employed was 0.3 g/anode. After mixing for 1 minute, the mixture was placed into a rolling device to make a ribbon. The produced catalyst ribbon was placed on a nickel grid (wire diameter 0.14 mm) and pressed thereon, yielding the anode material. The ribbon was cut into anode pieces of 17 cm². The electrochemical activity on the basis of the discharge characteristics in power-time and energy-time modes was investigated. Discharge characteristics of the anode were obtained in a cell (volume 50 cm³, distance between electrodes—4 mm, air cathode) with sodium borohydride as a fuel. 6.6 N KOH was used as the electrolyte. The cell was connected to a MACCOR® measuring system (Maccor, Inc., Tulsa, Okla., USA).

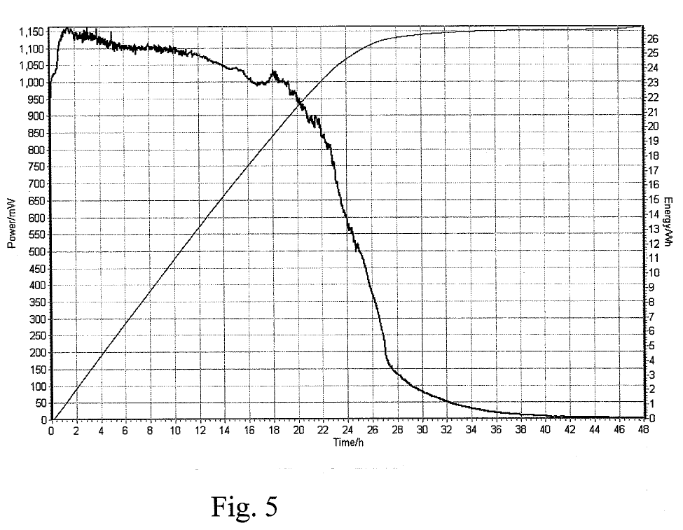

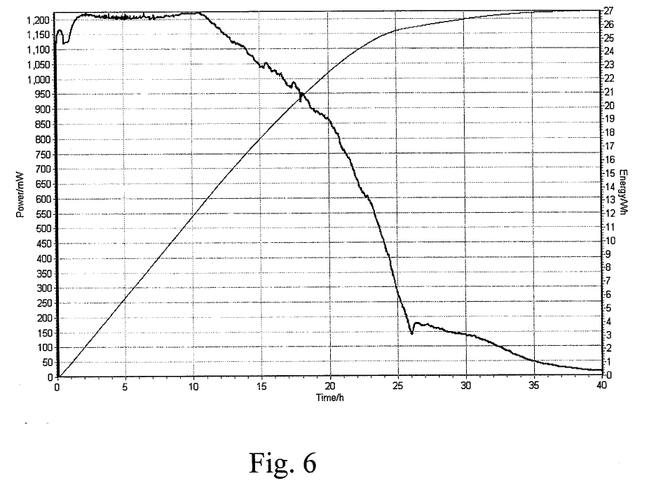

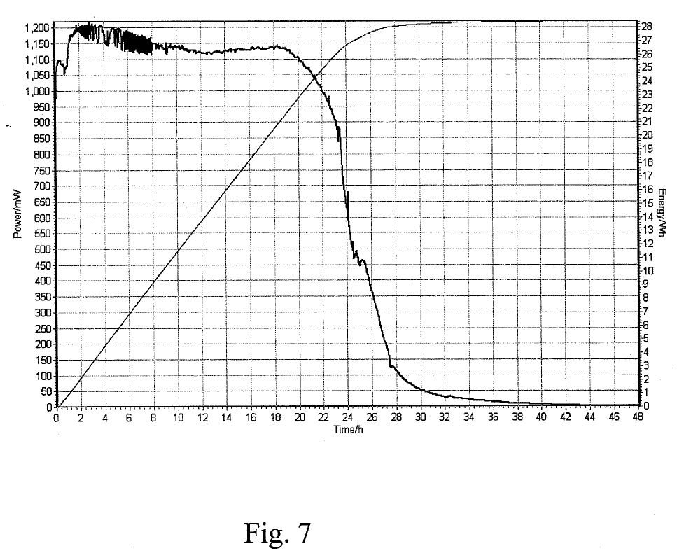

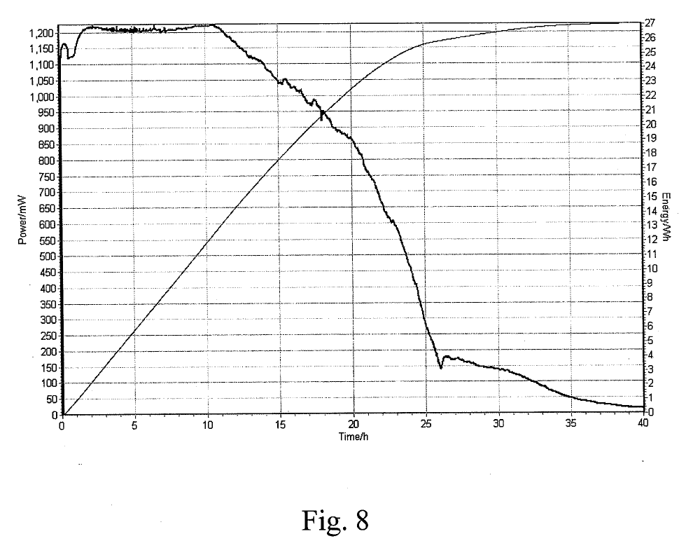

The results are summarized in FIGS. 5-8 and in Table 3 below. Note: In FIGS. 5-8 from left to right:descending plot—power, rising plot—produced energy.

TABLE 1
Productivity of PtPd/C Catalysts as Function
of Noble Metal Dispersion

| | | | Support | | | Q | Q |
|---|---|---|---|---|---|---|---|
| | | | Specific | Crystal | | [C] | [C] |
| | | | Surface | Size | | per 1 mg | per 1 mg |
| Example | Pt | Pd | Area | (XRD) | Molar Ratio | of | of |
| No. | [0079] | [0080] | [0081] | [nm] | CO/Metal(s)*⁾ | Catalyst | Metal(s) |
| 1 | 5.0 | 5.0 | 241 | 11 | 0.10 | 2.5 | 25 |
| 2 | 2.5 | 2.5 | 2000 | <2 | 0.72 | 3.8 | 76 |
| 3 | 2.5 | 2.5 | 2000 | <2 | 0.73 | 3.4 | 68 |
| 4 | 2.5 | 2.5 | 2000 | <2 | 0.76 | 3.3 | 66 |
| 5 | 2.5 | 2.5 | 2000 | <2 | 0.61 | 3.0 | 60 |
| 6 | 2.5 | 2.5 | 2000 | <2 | 0.63 | 3.1 | 62 |
| 7 | 2.5 | 2.5 | 64 | 3.5 | 0.33 | 1.9 | 38 |
| 8 | 2.5 | 2.5 | 2000 | 2.0 | 0.52 | 2.6 | 52 |
| 9 | 2.5 | 2.5 | 64 | 3.6 | 0.30 | 1.7 | 34 |
| 10 | 2.5 | 2.5 | 2000 | 2 | 0.50 | 2.7 | 54 |
| 11 | 2.5 | 2.5 | 2000 | <2 | 0.63 | 4.6 | 92 |
| 12 | 2.5 | 2.5 | 2000 | 3.9 | 0.28 | 1.5 | 30 |
| 13 | 2.5 | 2.5 | 2000 | 2 | 0.50 | 3.9 | 78 |
| 14 | 2.0 | 2.0 | 2000 | 2.5 | 0.41 | 2.9 | 72.5 |
| 15 | 2.5 | 0.5 | 2000 | <2 | 0.64 | 1.9 | 57 |
| 16 | 0.5 | 2.5 | 2000 | 2.5 | 0.40 | 1.2 | 40 |
| 17 | 2.5 | 0.5 | 2000 | 2 | 0.50 | 1.8 | 54 |
| 18 | 2.5 | — | 2000 | <2 | 0.83 | 1.0 | 40 |
| 19 | 2.5 | — | 2000 | <2 | 0.84 | 1.2 | 48 |
| 20 | 2.5 | — | 2000 | <2 | 0.75 | 0.9 | 36 |
| 21 | 1.0 | — | 2000 | <2 | 0.73 | 0.6 | 60 |
| 22 | — | 5 | 2000 | <2 | 0.59 | 0.5 | 10 |

*⁾(Pt + Pd)

TABLE 2
Productivity of PtPd/C Catalysts as a Function
of Noble Metal Distribution

| | | | | | | Q | Q |
|---|---|---|---|---|---|---|---|
| | | | | Crystal | | [C] | [C] |
| | | | | Size | Molar | per | per 1 mg |
| Example | Pt | Pd | Metal | (XRD) | Ratio | 1 mg of | of |
| No. | [0082] | [0083] | Distribution | [nm] | CO/Metals | Catalyst | Metals |
| 6 | 2.5 | 2.5 | uniform | <2 | 0.63 | 3.1 | 62 |
| 11 | 2.5 | 2.5 | peripheral | <2 | 0.63 | 4.6 | 92 |
| 13 | 2.5 | 2.5 | peripheral | 2 | 0.50 | 3.9 | 78 |
| 14 | 2.0 | 2.0 | peripheral | 2.5 | 0.41 | 2.9 | 72.5 |

Note:
specific area of the support - 2000 m²/g

As shown in Table 1, an increase in noble metal dispersion raises the activity of the electrocatalyst (Examples 2-5, 8, 10-12, 15-17) by a factor of 2-3 in comparison with the comparative catalyst (Example 1). Moreover, even catalysts with a support which has a relatively low specific surface area (Examples 7 and 9, S=64 m²/g as compared with 241 m²/g for Vulcan XC-72, Example 1, comparative catalyst) are 1.4-1.5 times more active than the comparative catalyst.

An increased efficiency of highly dispersed noble metals (per 1 mg of noble metals) is demonstrated for catalysts of different compositions (Examples 15-17), as well as for catalysts containing only Pt (Examples 18-21). However, the catalyst containing only Pd was less active despite a high concentration of Pd (5%, Example 22).

A positive effect of a non-uniform (peripheral) distribution of active metal is demonstrated in Table 2. Some catalysts with peripheral location (i.e., predominantly on the outer surfaces of support particles) of the active component (Examples 11, 13, 14) are more active (per 1 mg of noble metal) than a sample with a relatively uniform distribution of the active metal component (Example 6) despite a lower dispersion (Examples 13 and 14) due to a better availability of active sites for reactants.

TABLE 3
Activity of Fuel Cells with Anodes Comprising Highly Dispersed
and Predominantly Peripherally Located Active Metals
Example 24, FIGS. 5–8)

| | | | | Indices after | | Power | Energy |
|---|---|---|---|---|---|---|---|
| | | Molar | | 24 h - test | | per 1 mg | per 1 mg |
| Catalyst, | PtPd, | Ratio | Metal | Power | Energy | of metals | of metals |
| Example No. | [0084] | CO/Metals | Distribution | [mW] | [W * h] | [mW] | [W * h] |
| 1 | 10 | 0.1 | not measured | 600 | 24.70 | 20 | 0.82 |
| (comparison) | | | | | | | |
| 6 | 5 | 0.63 | uniform | 450 | 25.5 | 30 | 1.70 |
| 13 | 5 | 0.50 | peripheral | 600 | 26.8 | 40 | 1.79 |
| 14 | 4 | 0.41 | peripheral | 430 | 25.3 | 36 | 2.11 |

The data summarized in Table 3 demonstrate the advantage of fuel cells containing catalysts with highly dispersed and peripherally located active metals. The highly dispersed catalyst of Example 6 exceeds the catalyst of Example 1 of low dispersion despite a lower content of noble metals in Example 6. The catalyst of Example 13 affords higher power and produces more energy than the catalyst of Example 6 despite a lower dispersion due to the peripheral location and, respectively, a better contact between active sites and reactants. The “peripheral” catalyst of Example 14 shows an activity close to that of the catalyst of Example 6 and the highest energy (per 1 mg of metals) despite a lower content of noble metal and a lower dispersion. Hence, some advantages of highly dispersed and “peripherally located”-catalysts demonstrated in the catalyst test (Tables 1 and 2) are valid in the fuel cell test.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method of preparing a supported platinum and/or palladium electrocatalyst, wherein the method comprises contacting an electrically conductive particulate support which comprises adsorbed polynuclear hydroxo complexes (PHC) of at least one of platinum (Pt) and palladium (Pd) with a reducing agent.

2. The method of claim 1, wherein the electrically conductive support comprises carbon.

3. The method of claim 1, wherein the PHC comprise at least platinum.

4. The method of claim 1, wherein the support has a specific surface area of from about 50 m²/g to about 2,500 m²/g.

5. The method of claim 1, wherein the support has a specific surface area of at least about 700 m²/g.

6. The method of claim 1, wherein the support has a particle size of from about 0.5 μm to about 100 μm.

7. The method of claim 4, wherein the support comprises from 0 to about 1.2 cm³/g of micropores.

8. The method of claim 1, wherein the support comprises the at least one of Pt and Pd, calculated as metals, in a total concentration of from about 0.5% to about 10% by weight based on a total weight of support plus metal.

9. The method of claim 8, wherein the total concentration is not higher than about 5% by weight.

10. The method of claim 3, wherein an atomic ratio Pt:Pd is from about 10:1 to about 1:10.

11. The method of claim 10, wherein the atomic ratio Pt:Pd is from about 5:1 to about 1:5.

12. The method of claim 1, wherein the reducing agent comprises hydrogen gas.

13. The method of claim 1, wherein the reducing agent comprises one or more of formic acid and salts thereof, a borohydride compound, hydrazine and formaldehyde.

14. The method of claim 1, wherein the PHC have been obtained by a process which comprises contacting in an aqueous medium at least one of a Pd species and a Pt species with an alkaline agent.

15. The method of claim 14, wherein the at least one of a Pd species and a Pt species comprises at least one halide complex of Pd or Pt.

16. The method of claim 15, wherein the at least one halide complex comprises a chloride complex.

17. The method of claim 15, wherein the at least one halide complex comprises a chloride complex of at least one of Pt^{II}, Pt^{IV} and Pd^{II}.

18. The method of claim 17, wherein the alkaline agent is selected from carbonates, bicarbonates and hydroxides of alkali and alkaline earth metals.

19. The method of claim 15, wherein the contacting is carried out at a temperature of from about 15° C. to about 30° C.

20. The method of claim 14, wherein the method comprises contacting the at least one of a Pd species and a Pt species with the alkaline agent prior to contacting a resultant mixture with the support.

21. The method of claim 14, wherein the method comprises contacting the at least one of a Pd species and a Pt species with the support and then contacting it with the alkaline agent.

22. The method of claim 20, wherein the support is contacted with an oxidant at least one of prior to and concurrently with the contacting of the resultant mixture with the support.

23. The method of claim 22, wherein the oxidant comprises at least one of H₂O₂, NaOCl, O₂, Cl₂ and HNO₃.

24. The method of claim 21, wherein the support is contacted with an oxidant at least one of prior to and concurrently with the contacting of the support with the least one of a Pd species and a Pt species.

25. The method of claim 24, wherein the oxidant comprises at least one of H₂O₂, NaOCl, O₂, Cl₂ and HNO₃.

26. The method of claim 20, wherein the support is contacted with an electrolyte at least one of prior to and concurrently with the contacting of the resultant mixture with the support.

27. The method of claim 26, wherein the electrolyte comprises at least one of HCl, HClO₄, CH₃COOH, H₂SO₄, NaNO₃, Na₂SO₄, NaCl, CH₃COONa and NaClO₄.

28. The method of claim 21, wherein the support is contacted with an electrolyte at least one of prior to and concurrently with the contacting of the support with the least one of a Pd species and a Pt species.

29. The method of claim 28, wherein the electrolyte comprises at least one of HCl, HClO₄, CH₃COOH, H₂SO₄, NaNO₃, Na₂SO₄, NaCl, CH₃COONa and NaClO₄.

30. A method of preparing a carbon-supported platinum/palladium electrocatalyst, wherein the method comprises contacting a carbon support having a specific surface area of from about 50 m²/g to about 2,500 m²/g and comprising adsorbed polynuclear hydroxo complexes (PHC) of platinum (Pt) and palladium (Pd) at an atomic ratio Pt:Pd of from about 10:1 to about 1:10 in a total amount of from about 0.5% to about 10% by weight, calculated as metals and based on a total weight of carbon support plus metals, with one or more reducing agents selected from hydrogen, formic acid and salts thereof, borohydride compounds, hydrazine and formaldehyde.

31. The method of claim 30, wherein the carbon support has a particle size of from about 0.5 μm to about 100 μm and comprises from 0 to about 1.2 cm³/g of micropores.

32. The method of claim 31, wherein the atomic ratio Pt:Pd is from about 5:1 to about 1:5.

33. The method of claim 30, wherein the PHC have been obtained by a process which comprises contacting in an aqueous medium a chloride complex of at least one of Pt^{II}, Pt^{IV} and Pd^{II} with an alkaline agent comprising at least one of NaHCO₃, Na₂CO₃ and NaOH.

34. The method of claim 33, wherein the contacting is carried out at a temperature of from about 15° C. to about 30° C.

35. The method of claim 33, wherein the method comprises at least one of (a) contacting the chloride complex with the alkaline agent prior to contacting a resultant mixture with the carbon support and (b) contacting the chloride complex with the carbon support and then contacting it with the alkaline agent.

36. The method of claim 35, wherein the carbon support is contacted with an oxidant selected from one or more of H₂O₂, NaOCl, O₂, Cl₂ and HNO₃ at least one of (a) at least one of prior to and concurrently with the contacting of the resultant mixture with the carbon support and (b) at least one of prior to and concurrently with the contacting of the carbon support with the chloride complex.

37. A method of preparing a carbon-supported platinum and/or palladium electrocatalyst, wherein the method comprises contacting with a reducing agent an electrically conductive support having a specific surface area of from about 50 m²/g to about 2,500 m²/g and comprising adsorbed species which have been obtained by a process which comprises contacting one or more halide complexes of at least one of Pt^{II}, Pt^{IV} and Pd^{II} with an alkaline agent in an aqueous medium.

38. The method of claim 37, wherein the one or more halide complexes comprise at least one chloride complex.

39. The method of claim 38, wherein the alkaline agent is selected from carbonates, bicarbonates and hydroxides of alkali and alkaline earth metals.

40. The method of claim 38, wherein an atomic ratio Pt:Pd of from about 10:1 to about 1:10 is employed.

41. The method of claim 40, wherein Pt and Pd are employed in an amount which results in a total amount of Pt and Pd of from about 0.5% to about 10% by weight, calculated as metals and based on a total weight of support plus metals.

42. The method of claim 41, wherein the reducing agent is selected from one or more of hydrogen, formic acid and salts thereof, borohydride compounds, hydrazine and formaldehyde.

43. The method of claim 37, wherein the method comprises contacting the one or more halide complexes with the alkaline agent prior to contacting a resultant mixture with the support.

44. The method of claim 37, wherein the method comprises contacting the one or more halide complexes with the support and then contacting them with the alkaline agent.

45. An electrocatalyst which is obtained by the method of claim 1.

46. The electrocatalyst of claim 45, wherein an average crystal size of the at least one of Pt and Pd on at least outer surfaces of particles of the support is not higher than about 4 nm.

47. The electrocatalyst of claim 46, wherein the at least one of Pt and Pd is predominantly present on the outer surfaces of particles of the support.

48. The electrocatalyst of claim 46, wherein the at least one of Pt and Pd is substantially evenly distributed between pores and outer surfaces of particles of the support.

49. An electrocatalyst which is obtained by the method of claim 14.

50. The electrocatalyst of claim 49, wherein the electrocatalyst has an activity, determined in a polarization test and expressed as Coulomb/weight unit of Pt and/or Pd metal, which is at least about 1.5 times an activity of an electrocatalyst which has been obtained by an identical process but without contacting the least one of a Pd species and a Pt species with an alkaline agent before contacting the support with the reducing agent.

51. An electrocatalyst which comprises metallic Pt and/or metallic Pd supported on carbon particles, wherein crystals of the metallic Pt and/or metallic Pd are present predominantly on outer surfaces of the carbon particles and have an average size of not more than about 4 nm at least on said outer surfaces.

52. An anode for a liquid fuel cell which comprises the electrocatalyst of claim 45.

53. A fuel cell which comprises the anode of claim 52.

54. The fuel cell of claim 53, wherein the fuel cell is at least one of a direct liquid fuel cell and a portable fuel cell.

55. The fuel cell of claim 53, wherein the fuel cell comprises a liquid fuel.

56. The fuel cell of claim 55, wherein the fuel comprises at least one of a hydride compound and a borohydride compound.

57. The fuel cell of claim 56, wherein the fuel comprises at least one of NaBH₄ and KBH₄.

58. A method of electrocatalytically oxidizing a borohydride compound in an alkaline medium, wherein the method comprises contacting the borohydride compound with the electrocatalyst of claim 51.

59. A method of increasing the activity of a supported metallic Pt and/or Pd catalyst without increasing the amount of Pt and/or Pt used for the production of the catalyst, wherein the method comprises contacting with a reducing agent a support comprising adsorbed polynuclear hydroxo complexes (PHC) of at least one of Pt and Pd.

60. The method of claim 59, wherein the PHC have been obtained by a process which comprises contacting one or more halide complexes of at least one of Pt^{II}, Pt^{IV} and Pd^{II} with an alkaline agent.
